(19) United States
(12) Patent Application Publication
(10) Pub. No.: US 2026/0353253 A1
(43) Pub. Date: Nov. 5, 2026

(54) SECONDARY WIRELESS ACCESS NODE SELECTION AND USAGE

(71) Applicant: T-MOBILE INNOVATIONS LLC, Overland Park, KS (US)

(72) Inventor: John Carlo Hernandez Ventura, Sammamish, WA (US)

(21) Appl. No.: 19/198,826

(22) Filed: May 5, 2025

(51) Int. Cl. H04W 48/08; H04B 17/318; H04B 17/336

(52) U.S. Cl. CPC H04W 48/08; H04B 17/328; H04B 17/336

(57) ABSTRACT

In some examples, a primary wireless access node wirelessly communicates with a user device. The primary wireless access node wirelessly transfers one or more secondary node selection criteria to the user device. The primary wireless access node wirelessly receives signal measurements for one or more secondary wireless access nodes from the user device in response to the one or more secondary node selection criteria. The primary wireless access node configures the one or more of the secondary wireless access nodes to communicate with the user device in response to the signal measurements and the one or more secondary node selection criteria. The one or more of the configured secondary wireless access nodes wirelessly communicate with the user device.

### TECHNICAL BACKGROUND

Wireless data systems provide wireless data services to wireless user devices like phones, vehicles, robots, and computers. The wireless data services include internet-access, machine-communications, media-streaming, or some other data product. For example, a fleet of aerial vehicles may use a wireless communication network for vehicle tracking and control. In another example, a team of gamers may use wireless internet access to play an interactive augmented-reality game. The wireless data systems comprise wireless access nodes like communication satellites, new radio NodeBs, and wireless fidelity hotspots. The wireless user devices and the wireless access nodes exchange network signaling and user data to implement these wireless data services.

The wireless access nodes use Carrier Aggregation (CA) to increase the Radio Frequency (RF) bandwidth for the wireless user devices. The increased RF bandwidth generally improves the data rate and the reliability of the wireless data services. CA simultaneously uses multiple wireless access nodes and their frequency bands in parallel to serve the same wireless user device. Initially, the wireless user device selects and uses a primary wireless access node. If the uplink buffer in the wireless user device and/or the downlink buffer in the primary wireless access node exceeds a CA threshold, then the primary wireless access node selects a secondary wireless access node to help. The selection is based on which secondary wireless access node has the most RF bandwidth.

For the uplink, the wireless user device transfers its buffered uplink data that is below the CA threshold to the primary wireless access node. The wireless user device transfers the buffered uplink data that exceeds the CA threshold to the selected secondary wireless access node, and the secondary wireless access node forwards this excess uplink data to the primary wireless access node. For the downlink, the primary wireless access node transfers its buffered downlink data that is below the CA threshold to the wireless user device. The primary wireless access node transfers its buffered downlink data that exceeds the CA threshold to the selected secondary wireless access node, and the secondary wireless access node forwards this excess downlink data to the wireless user device.

### TECHNICAL OVERVIEW

In some examples, a wireless communication system comprises a primary wireless access node and secondary wireless access nodes. The primary wireless access node wirelessly communicates with a user device. The primary wireless access node wirelessly transfers one or more secondary node selection criteria to the user device. The primary wireless access node wirelessly receives signal measurements for one or more of the secondary wireless access nodes from the user device in response to the one or more secondary node selection criteria. The primary wireless access node configures the one or more of the secondary wireless access nodes to communicate with the user device in response to the signal measurements and the one or more secondary node selection criteria. The one or more of the configured secondary wireless access nodes wirelessly communicate with the user device.

In some examples, a method comprises the following operations. Wirelessly communicate with a user device via a primary wireless access node. Wirelessly transfer one or more secondary node selection criteria to the user device. Wirelessly receive signal measurements for one or more of the secondary wireless access nodes from the user device in response to the one or more secondary node selection criteria. Configure the one or more of the secondary wireless access nodes to communicate with the user device in response to the signal measurements and one or more secondary node selection criteria. Wirelessly communicate with user device via the one or more of the configured secondary wireless access nodes.

In some examples, a method comprises the following operations. Wirelessly communicate with a primary wireless access node. Wirelessly receive one or more secondary node selection criteria from the primary wireless access node. Determine signal measurements for secondary wireless access nodes in response to the one or more secondary node selection criteria. Select one or more of the secondary wireless access nodes in response to the signal measurements and the one or more secondary node selection criteria. Wirelessly transfer the signal measurements for the one or more of the selected secondary wireless access nodes to the primary wireless access node. Wirelessly communicate with the one or more of the selected secondary wireless access nodes.

### DESCRIPTION OF THE DRAWINGS

FIG. 1 illustrates an exemplary data system to select and use secondary wireless access nodes.

FIG. 2 illustrates an exemplary operation of a primary wireless access node in the data system to select and use the secondary wireless access nodes.

FIG. 3 illustrates an exemplary operation of a wireless user device in the data system to select and use the secondary wireless access nodes.

FIG. 4 illustrates an exemplary operation of the data system to select and use the secondary wireless access nodes.

FIG. 5 illustrates an exemplary wireless communication network to select and use secondary wireless access nodes.

FIG. 6 illustrates an exemplary User Equipment (UE) in the wireless communication network that selects and uses the secondary wireless access nodes.

FIG. 7 illustrates an exemplary terrestrial Fifth Generation New Radio (5GNR) Access Node (AN) in the wireless communication network that selects and uses the secondary wireless access nodes.

FIG. 8 illustrates an exemplary Wireless Fidelity (WIFI) AN in the wireless communication network that selects and uses the secondary wireless access nodes.

FIG. 9 illustrates an exemplary Satellite (SAT) AN and SAT Ground Station (GND) in the wireless communication network that selects and uses the secondary wireless access nodes.

FIG. 10 illustrates an exemplary Network Function Virtualization Infrastructure (NFVI) in the wireless communication network that selects and uses the secondary wireless access nodes.

FIG. 11 illustrates an exemplary operation of the wireless communication network to select and use the secondary wireless access nodes.

FIG. 12 illustrates an exemplary operation of the wireless communication network to select an amount of user data to offload to the secondary wireless access nodes.

FIG. 13 illustrates exemplary processing circuitry to select and use secondary wireless access nodes.

### DETAILED DESCRIPTION

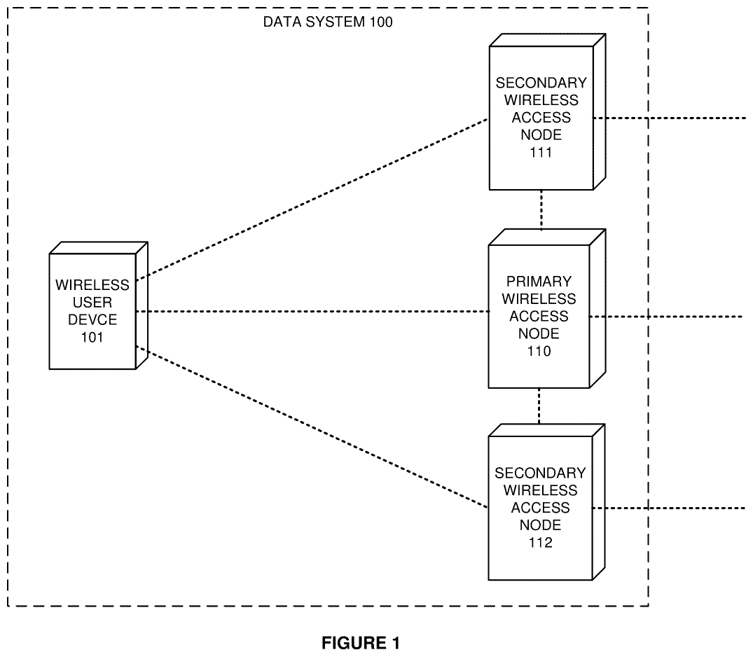

FIG. 1 illustrates exemplary data system 100 to select and use secondary wireless access nodes 111-112. Data system 100 provides data services like internet-access, machine control, video-calling, data messaging, and the like. Data system 100 comprises wireless user device 101, primary wireless access node 110, and secondary wireless access nodes 111-112. Wireless user device 101 could be a phone, computer, vehicle, robot, and/or some other user apparatus with wireless communication components. Wireless access nodes 110-112 could be NodeBs, hotspots, satellites, and/or some other type of wireless transceivers.

In some examples, wireless user device 101 and primary wireless access node 110 wirelessly communicate with one another. Primary wireless access node 110 wirelessly transfers one or more secondary node selection criteria to wireless user device 101. The one or more secondary node selection criteria could include node identifiers and frequency bands along with thresholds for Reference Signal Received Power (RSRP), Reference Signal Received Quality (RSRQ), Signal-to-Interference and Noise Ratio (SINR), Block Error Rate (BLER), and/or Channel Quality Indicator (CQI)—although the selection criteria could be some other rule and/or measurement. Wireless user device 101 wirelessly receives the one or more secondary node selection criteria, and in response, determines signal measurements for secondary wireless access nodes 111-112. For example, wireless user device 101 may measure the RSRP of pilot signals from secondary wireless access nodes 111-112. Wireless user device 101 selects one or both of secondary wireless access nodes 111-112 in response to the signal measurements and the one or more secondary node selection criteria. For example, wireless user device 101 may select secondary wireless access node 111 because its RSRP exceeds an RSRP threshold but not select secondary wireless access node 112 because its RSRP falls below the RSRP threshold. Wireless user device 101 wirelessly transfers the signal measurements for selected secondary wireless access nodes 111-112 to primary wireless access node 110. Primary wireless access node 110 wirelessly receives the signal measurements. Primary wireless access node 110 configures the one or both of selected secondary wireless access nodes 111-112 to communicate with wireless user device 101 in response to the signal measurements and the one or more secondary node selection criteria. For example, primary wireless access node 110 may configure secondary wireless access node 111 because its RSRP exceeds the RSRP threshold. The configuration includes information like the device and node identifiers, frequency bands, network addresses, and data rates. Configured secondary wireless access nodes 111-112 wirelessly communicate with wireless user device 101.

The above operation may comprise a type of Carrier Aggregation (CA). In such CA, primary access node 110 may be referred to as a PCell, and the secondary wireless access nodes 111-112 may be referred to as SCells. A PCell and an SCell may be provided by different wireless transceivers (e.g., remote radio units (RRUs)) that communicate with wireless devices, such as wireless user device 101, using different carrier bands. A SCell may be co-located at the same base station (e.g., nodeB) as a PCell, or may be located at a different base station than the PCell. In examples in which a SCell and a PCell are co-located, the SCell and the PCell may be connected to the same baseband unit (BBU)) of the shared base station (e.g., nodeB).

In some examples, the one or more secondary node selection criteria excludes secondary wireless access nodes 111-112 that require antenna switching by wireless user device 101. For example, when both secondary wireless access nodes 111-112 have adequate signal measurements for selection but secondary wireless access node 111 requires antenna switching by wireless user device 101, primary wireless access node 110 excludes secondary wireless access node 111 from selection due to the antenna switching requirement. Antenna switching is typically required when the primary and secondary nodes use different multiplexing schemes like frequency division and time division.

In some examples, the one or more secondary node selection criteria excludes secondary wireless access nodes 111-112 that do not share a NodeB with primary wireless access node 110. For example, when both secondary wireless access nodes 111-112 have adequate signal measurements for selection but secondary wireless access node 111 does not share a NodeB with primary wireless access node 110, then primary wireless access node 110 may exclude secondary wireless access node 111 from selection since it does not share its NodeB. Wireless access nodes that share a NodeB are co-located on the same structure and use the same computer hardware.

In some examples, primary wireless access node 110 transfers the one or more secondary node selection criteria to wireless user device 101 in a Radio Resource Control (RRC) Reconfiguration message. In some examples, primary wireless access node 110 receives the signal measurements from wireless user device 101 in an RRC Reconfiguration Complete message.

In some examples, primary wireless access node 110 determines primary bandwidth for itself and secondary bandwidths for selected secondary wireless access nodes 111-112. Primary wireless access node 110 then selects an amount of user data to offload to selected secondary wireless access nodes 111-112 based on the primary bandwidth, the secondary bandwidths, and the signal measurements. For example, primary wireless access node 110 may select and offload all of the user data for wireless user device 101 in its downlink buffer to selected secondary wireless access node 111. Wireless user device 101 and selected secondary wireless access nodes 111-112 wirelessly communicate to transfer the selected amounts of the user data. In some examples, primary wireless access node 110 only offloads the user data when the secondary bandwidth is greater than the primary bandwidth. For example, primary wireless access node 110 may select all of its uplink and downlink data to offload to secondary wireless access node 111 when the secondary bandwidth of secondary wireless access node 111 is greater than the primary bandwidth of primary wireless access node 110. Primary wireless access node 110 may only offload the data to secondary wireless access nodes 111-112 when these nodes have SINR, BLER, and CQI that all exceed corresponding thresholds.

In some examples, wireless user device 101 and wireless access nodes 110-112 wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), satellite data communications and/or some other wireless protocol. Wireless user device 101 and wireless access nodes 110-112 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

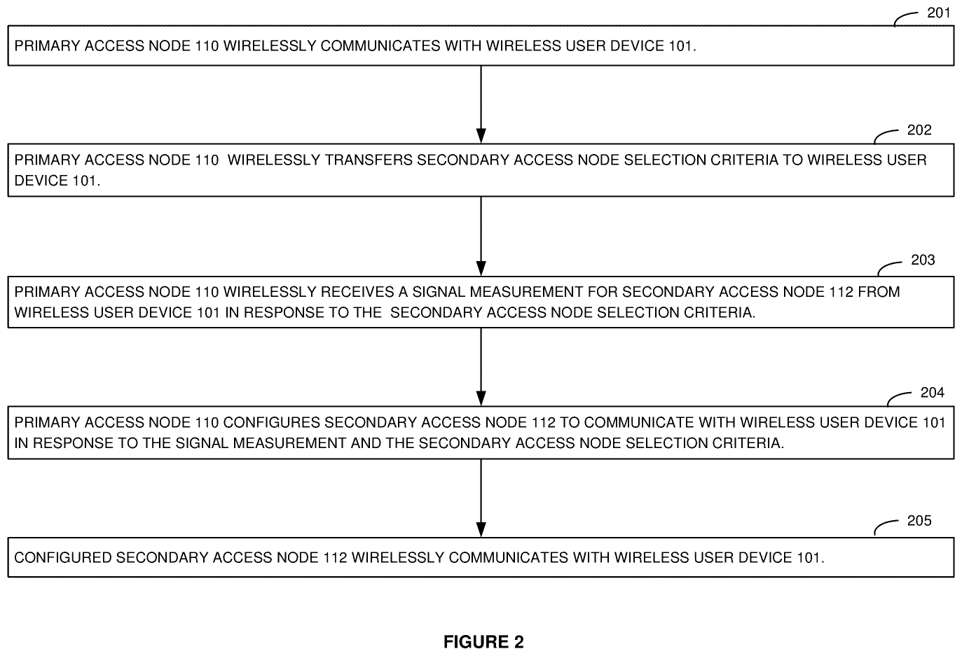

FIG. 2 illustrates an exemplary operation of primary wireless access node 110 in data system 100 to select and use secondary wireless access node 112. The operation may differ in other examples. Primary wireless access node 110 wirelessly communicate with wireless user device 101 (201). Primary wireless access node 110 wirelessly transfers one or more secondary node selection criteria to wireless user device 101 (202). Primary wireless access node 110 wirelessly receives signal measurements for secondary wireless access node 112 from wireless user device 101 in response to the signal measurements and the one or more secondary node selection criteria (203). Primary wireless access node 110 configures secondary wireless access node 112 to communicate with wireless user device 101 in response to the signal measurement and the one or more secondary node selection criteria (204). Configured secondary wireless access node 112 wirelessly communicates with wireless user device 101.

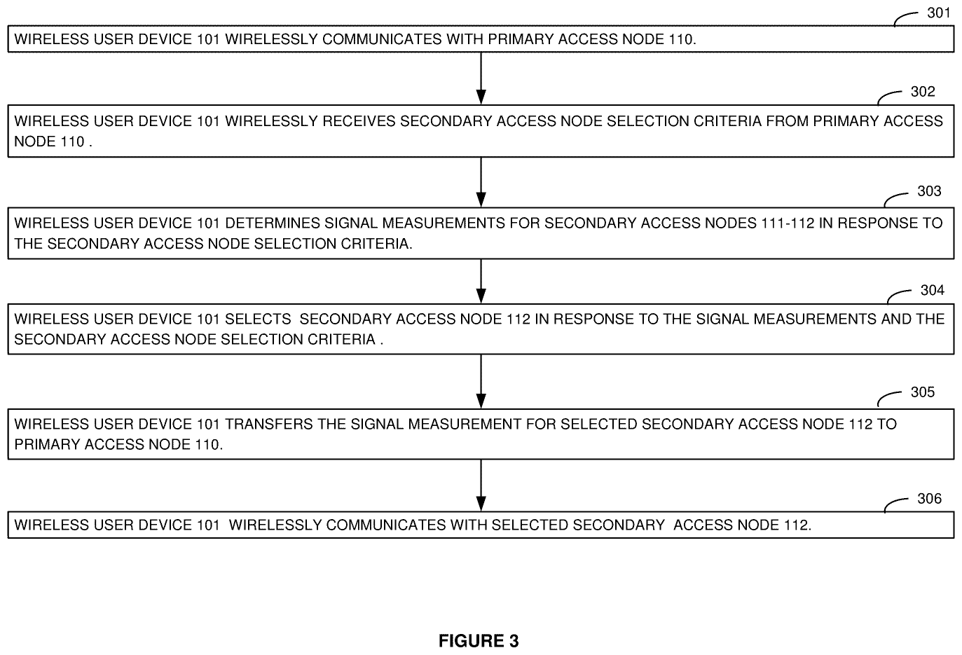

FIG. 3 comprises illustrates an exemplary operation of wireless user device 101 in data system 100 to select and use secondary wireless access node 112. The operation may differ in other examples. Wireless user device 101 wirelessly communicates with primary wireless access node 110 (301). Wireless user device 101 wirelessly receives one or more secondary node selection criteria from primary wireless access node 110 (302). Wireless user device 101 determines signal measurements for secondary wireless access nodes 111-112 in response to the one or more secondary node selection criteria (303). Wireless user device 101 selects secondary wireless access node 112 in response to the signal measurements and the one or more secondary node selection criteria (304). For example, secondary wireless access node 112 may have an RSRP that exceeds an RSRP threshold while secondary wireless access node 111 does not. Wireless user device 101 wirelessly transfers the signal measurement for selected secondary wireless access node 112 to primary wireless access node 110 (305). Wireless user device 101 wirelessly communicates with selected secondary wireless access node 112.

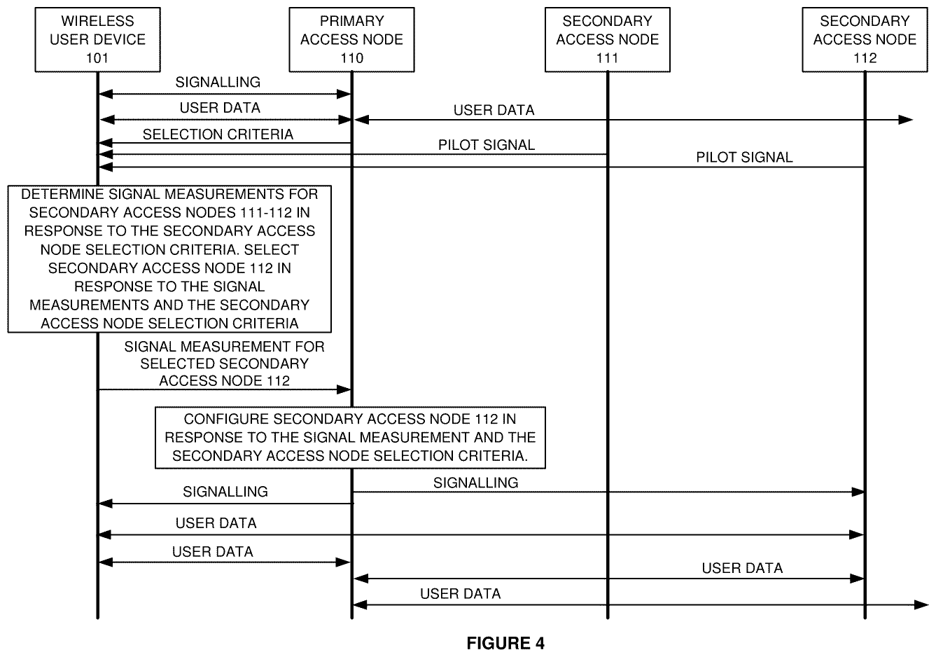

FIG. 4 illustrates an exemplary operation of data system 100 to select and use secondary wireless access node 112. The operation may differ in other examples. Wireless user device 101 and primary wireless access node 110 wirelessly exchange signaling. Wireless user device 101 and an external system (not shown) exchange user data over primary wireless access node 110. For example, wireless user device 101 may exchange emails with an external email server over primary wireless access node 110. Primary wireless access node 110 wirelessly transfers one or more secondary node selection criteria to wireless user device 101. The one or more secondary node selection criteria could be node identifiers and frequency bands along with thresholds for RSRP, RSRQ, SINR, BLER, CQI, and/or some other measurement and rule. Wireless user device 101 determines signal measurements for the pilot signals from secondary wireless access nodes 111-112 in response to the one or more secondary node selection criteria. Wireless user device 101 selects secondary wireless access node 112 in response to the signal measurements and the one or more secondary node selection criteria. For example, wireless user device 101 may select secondary wireless access node 112 because its RSRP and SINR exceed corresponding RSRP and SINR thresholds. Wireless user device 101 wirelessly transfers the signal measurement for selected secondary wireless access node 112 to primary wireless access node 110. Primary wireless access node 110 configures secondary wireless access node 112 to communicate with wireless user device 101 in response to the signal measurement and the one or more secondary node selection criteria. For example, primary wireless access node 110 may configure secondary wireless access node 112 because its RSRP and SINR exceed the corresponding RSRP and SINR thresholds. Primary wireless access node 110 transfers signaling to secondary wireless access node 112 and wireless user device 101 to implement the secondary wireless access node selection. The configuration indicates secondary wireless access node 112 to wireless user device 101 and indicates wireless user device 101 to secondary wireless access node 112. Wireless user device 101 wirelessly exchanges user data with secondary wireless access node 112 and primary wireless access node 110. Secondary wireless access node 112 exchanges its user data with primary access node 110. Primary wireless access node 110 exchanges the user data with the external system. For example, wireless user device 101 may download video from an external content server over secondary wireless access node 112 and primary wireless access node 110.

Advantageously, data system 100 selects and uses secondary wireless access nodes 111-112 that have effective wireless communications with wireless user device 101. Moreover, primary access node 110 may efficiently offload all of its user data for wireless user device 101 to secondary wireless access nodes 111-112.

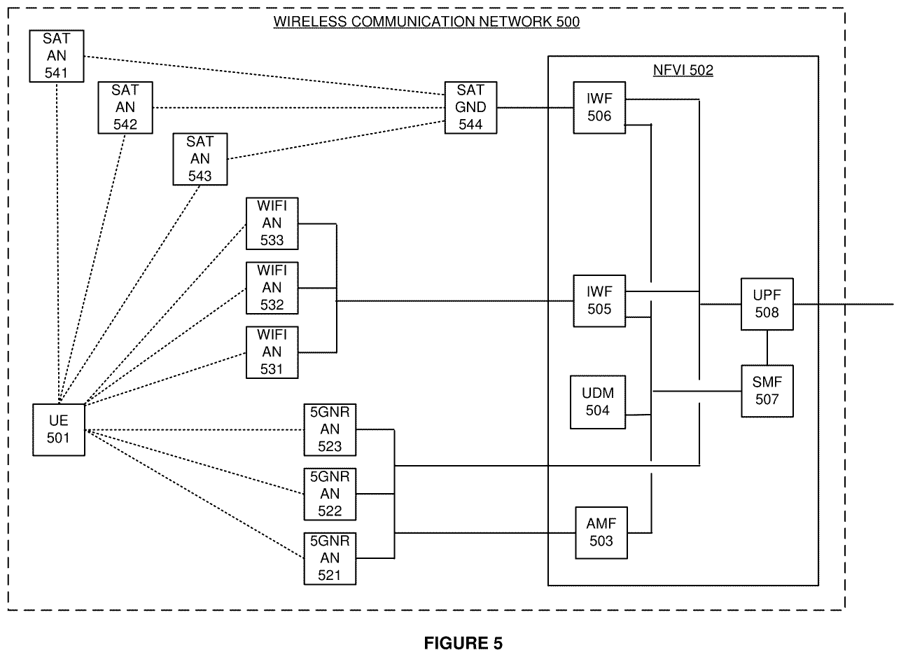

FIG. 5 illustrates exemplary wireless communication network 500 to select and use secondary wireless access nodes 522-523, 532-533, and 542-543. Wireless communication network 500 comprises an example of data system 100, although system 100 may differ. Wireless communication network 500 comprises User Equipment (UE) 501, Fifth Generation New Radio Access Nodes (5GNR ANs) 521-523, Wireless Fidelity Access Nodes (WIFI ANs) 531-533, Satellite Access Nodes (SAT ANs) 541-543, Satellite Ground Station (SAT GND) 544, and Network Function Virtualization Infrastructure (NFVI) 502. NFVI 502 comprises Access and Mobility Management Function (AMF) 503, Unified Data Management (UDM) 504, Interworking Functions (IWFs) 505-506, Session Management Function (SMF) 507, and User Plane Function (UPF) 508.

In a first example, UE 501 attaches to 5GNR AN 521 which operates as the primary wireless access node. UE 501 registers with AMF 503 over primary 5GNR AN 521. During the registration, UE 501 reports its capabilities for Carrier Aggregation (CA) to primary 5GNR AN 521. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to primary 5GNR AN 521. AMF 503 transfers the context to UE 501 over primary 5GNR AN 521. In response to the context, UE 501 wirelessly exchanges user data with external systems (not shown) over primary 5GNR AN 521 and UPF 508.

UE 501 reports its uplink buffer status to primary 5GNR AN 521. Primary 5GNR AN 521 determines its own downlink buffer status for UE 501. When one of the buffers exceeds a CA threshold, primary 5GNR AN 521 transfers a Radio Resource Control (RRC) Reconfiguration message to UE 501 that requests UE 501 to report which of ANs 522-523, if any, have a Reference Signal Received Power (RSRP) above an RSRP threshold. UE 501 measures the RSRP for secondary 5GNR ANs 522-523 and determines that AN 522 has an RSRP above the RSRP threshold but AN 523 does not. UE 501 returns an RRC Reconfiguration Complete message to primary 5GNR AN 521 that indicates secondary 5GNR AN 522 and its RSRP measurement. Primary 5GNR AN 521 confirms that secondary 5GNR AN 522 has an RSRP above the RSRP threshold.

If the uplink buffer in UE 501 has user data in excess of the CA threshold, then primary 5GNR AN 521 signals UE 501 to transfer the excess portion of the uplink data to secondary 5GNR AN 522. Primary 5GNR AN 521 signals secondary 5GNR AN 522 to receive this excess uplink data from UE 501 and to forward the excess uplink data to primary 5GNR AN 521. In response, UE 501 transfers the excess portion of the uplink data to secondary 5GNR AN 522, and secondary 5GNR AN 522 forwards this excess uplink data to primary 5GNR AN 521. UE 501 transfers the remaining portion of the uplink data directly to primary 5GNR AN 521. Primary 5GNR AN 521 transfers all of the uplink data to the external system over UPF 508. UE 501 determines Signal-to-Interference and Noise Ratio (SINR), Block Error Rate (BLER), and Channel Quality Indicator (CQI) for secondary 5GNR AN 522 during this data transfer.

If the downlink buffer in 5GNR AN 521 has user data for UE 501 in excess of the CA threshold, then primary 5GNR AN 521 signals secondary 5GNR AN 522 to receive this excess downlink data from primary 5GNR AN 521 and forward the excess downlink data to UE 501. Primary 5GNR AN 521 signals UE 501 to receive the excess downlink data from secondary 5GNR AN 522. In response, primary 5GNR AN 521 transfers the excess portion of the downlink data to secondary 5GNR AN 522, and secondary 5GNR AN 522 forwards this excess downlink data to UE 501. Primary 5GNR AN 521 transfers the remaining portion of the downlink data directly to UE 501. UE 501 determines the SINR, BLER, and CQI for secondary 5GNR AN 522 during this data transfer.

UE 501 subsequently reports its uplink buffer status to primary 5GNR AN 521. Primary 5GNR AN 521 determines its own downlink buffer status for UE 501. When one of the buffers exceeds a CA threshold, primary 5GNR AN 521 determines if secondary 5GNR AN 522 has more available bandwidth for UE 501 than primary 5GNR AN 521 does. For example, primary 5GNR AN 521 may have a bandwidth of 100 megahertz while secondary 5GNR AN 522 has a bandwidth of 200 megahertz. If secondary 5GNR AN 522 has more available bandwidth, then primary 5GNR AN 521 transfers an RRC Reconfiguration message to UE 501 that requests the SINR, BLER, and CQI for secondary 5GNR AN 522. UE 501 reports the SINR, BLER, and CQI for secondary 5GNR AN 522 to primary 5GNR AN 521. Primary 5GNR AN 521 compares the SINR, BLER, and CQI for secondary 5GNR AN 522 to corresponding SINR, BLER, and CQI thresholds. When secondary 5GNR AN 522 meets or exceeds these SINR, BLER, and CQI thresholds, primary 5GNR AN 521 offloads all of the buffered uplink data in UE 501 and/or all of the buffered downlink data to secondary 5GNR AN 522. Note that all of the uplink and/or downlink data is offloaded and not just the excess portion of data that is above the CA threshold.

To offload all of the uplink data, primary 5GNR AN 521 signals UE 501 to transfer all of the uplink data to secondary 5GNR AN 522. Primary 5GNR AN 521 signals secondary 5GNR AN 522 to receive all of the uplink data from UE 501 and to forward all of the uplink data to primary 5GNR AN 521. In response, UE 501 transfers the all of its buffered uplink data to secondary 5GNR AN 522, and secondary 5GNR AN 522 forwards all of this uplink data to primary 5GNR AN 521. Primary 5GNR AN 521 transfers all of the uplink data to the external system over UPF 508.

To offload all of the downlink data, primary 5GNR AN 521 signals secondary 5GNR AN 522 to receive all of the downlink data from primary 5GNR AN 521 and forward all of the downlink data to UE 501. Primary 5GNR AN 521 signals UE 501 to receive all of the downlink data from secondary 5GNR AN 522. In response, primary 5GNR AN 521 transfers all of its buffered downlink data to secondary 5GNR AN 522, and secondary 5GNR AN 522 forwards all of this downlink data to UE 501.

In a second example, UE 501 attaches to SAT AN 541 which operates as the primary wireless access node. UE 501 registers with AMF 503 over SAT AN 541, SAT GND 544, and IWF 506. During the registration, UE 501 reports its capabilities for CA to primary SAT AN 541. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to primary IWF 506. AMF 503 transfers the context to UE 501 over primary SAT AN 541. In response to the context, UE 501 wirelessly exchanges user data with the external systems over primary SAT AN 541, SAT GND 544, IWF 506, and UPF 508.

UE 501 reports its uplink buffer status to primary SAT AN 541. Primary SAT AN 541 determines its own downlink buffer status for UE 501. When one of the buffers exceeds a CA threshold, primary SAT AN 541 transfers a message to UE 501 that requests UE 501 to report which of ANs 542-543, if any, have a Received Signal Strength (RSS) above an RSS threshold. UE 501 measures the RSS for secondary SAT ANs 542-543 and determines that AN 542 has an RSS above the RSS threshold but AN 543 does not. UE 501 returns a message to primary SAT AN 541 that indicates secondary SAT AN 542 and its RSS measurement. Primary SAT AN 541 confirms that secondary SAT AN 542 has an RSS above the RSS threshold.

If the uplink buffer in UE 501 has user data in excess of the CA threshold, then primary SAT AN 541 signals UE 501 to transfer the excess portion of the uplink data to secondary SAT AN 542. Primary SAT AN 541 signals secondary SAT AN 542 to receive this excess uplink data from UE 501 and to forward the excess uplink data to primary SAT AN 541. In response, UE 501 transfers the excess portion of the uplink data to secondary SAT AN 542, and secondary SAT AN 542 forwards this excess uplink data to primary SAT AN 541. UE 501 transfers the remaining portion of the uplink data directly to primary SAT AN 541. Primary SAT AN 541 transfers all of the uplink data to the external system over SAT GND 544, IWF 506, and UPF 508. UE 501 determines the Signal-to-Noise Ratio (SNR) and Error Rate (ER) for secondary SAT AN 542 during this data transfer.

If the downlink buffer in SAT AN 541 has user data for UE 501 in excess of the CA threshold, then primary SAT AN 541 signals secondary SAT AN 542 to receive this excess downlink data from primary SAT AN 541 and forward the excess downlink data to UE 501. Primary SAT AN 541 signals UE 501 to receive the excess downlink data from secondary SAT AN 542. In response, primary SAT AN 541 transfers the excess portion of the downlink data to secondary SAT AN 542, and secondary SAT AN 542 forwards this excess downlink data to UE 501. Primary SAT AN 541 transfers the remaining portion of the downlink data directly to UE 501. UE 501 determines the SNR and ER for secondary SAT AN 542 during this data transfer.

UE 501 subsequently reports its uplink buffer status to primary SAT AN 541. Primary SAT AN 541 determines its own downlink buffer status for UE 501. When one of the buffers exceeds a CA threshold, primary SAT AN 541 determines if secondary SAT AN 542 has more available bandwidth for UE 501 than AN 541 does. If secondary SAT AN 542 has more available bandwidth, then primary SAT AN 541 transfers a message to UE 501 that requests the SNR and ER for secondary SAT AN 542. UE 501 reports the SNR and ER for secondary SAT AN 542 to primary SAT AN 541. Primary SAT AN 541 compares the SNR and ER for secondary SAT AN 542 to corresponding SNR and ER thresholds. When secondary SAT AN 542 meets or exceeds these SNR and ER thresholds, primary SAT AN 541 offloads all of the buffered uplink data and/or all of the buffered downlink data to secondary SAT AN 542. Note that all of the uplink and/or downlink data is offloaded and not just the excess portion of data that is above the CA threshold.

To offload the uplink data, primary SAT AN 541 signals UE 501 to transfer all of its buffered uplink data to secondary SAT AN 542. Primary SAT AN 541 signals secondary SAT AN 542 to receive all of the uplink data from UE 501 and to forward all of this uplink data to primary SAT AN 541. In response, UE 501 transfers the all of its buffered uplink data to secondary SAT AN 542, and secondary SAT AN 542 forwards all of this uplink data to primary SAT AN 541. Primary SAT AN 541 transfers all of the uplink data to the external system over SAT GND 544, IWF 506, and UPF 508.

To offload the downlink data, primary SAT AN 541 signals secondary SAT AN 542 to receive all of the downlink data from primary SAT AN 541 and forward all of the downlink data to UE 501. Primary SAT AN 541 signals UE 501 to receive all of the downlink data from secondary SAT AN 542. In response, primary SAT AN 541 transfers all of its buffered downlink data to secondary SAT AN 542, and secondary SAT AN 542 forwards all of this downlink data to UE 501.

In a third example, UE 501 attaches to WIFI AN 531 which operates as the primary wireless access node. UE 501 registers with AMF 503 over WIFI AN 531 and IWF 505. During the registration, UE 501 reports its capabilities for CA to primary WIFI AN 531. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to IWF 505. AMF 503 transfers the context to UE 501 over primary WIFI AN 531. In response to the context, UE 501 wirelessly exchanges user data with the external systems over primary WIFI AN 531, IWF 505, and UPF 508.

UE 501 reports its uplink buffer status to primary WIFI AN 531. Primary WIFI AN 531 determines its own downlink buffer status for UE 501. When one of the buffers exceeds a CA threshold, primary WIFI AN 531 transfers a message to UE 501 that requests UE 501 to report which of ANs 532-533, if any, have an RSS above an RSS threshold. UE 501 measures the RSS for secondary WIFI ANs 532-533 and determines that AN 532 has an RSS above the RSS threshold but AN 533 does not. UE 501 returns a message to primary WIFI AN 531 that indicates secondary WIFI AN 532 and its RSS measurement. Primary WIFI AN 531 confirms that secondary WIFI AN 532 has an RSS above the RSS threshold.

If the uplink buffer in UE 501 has user data in excess of the CA threshold, then primary WIFI AN 531 signals UE 501 to transfer the excess portion of the uplink data to secondary WIFI AN 532. Primary WIFI AN 531 signals secondary WIFI AN 532 to receive this excess uplink data from UE 501 and to forward the excess uplink data to primary WIFI AN 531. In response, UE 501 transfers the excess portion of the uplink data to secondary WIFI AN 532, and secondary WIFI AN 532 forwards this excess uplink data to primary WIFI AN 531. UE 501 transfers the remaining portion of the uplink data directly to primary WIFI AN 531. Primary WIFI AN 531 transfers all of the uplink data to the external system over IWF 505 and UPF 508. UE 501 determines the SNR for secondary WIFI AN 532 during this data transfer.

If the downlink buffer in WIFI AN 531 has user data for UE 501 in excess of the CA threshold, then primary WIFI AN 531 signals secondary WIFI AN 532 to receive this excess downlink data from primary WIFI AN 531 and forward the excess downlink data to UE 501. Primary WIFI AN 531 signals UE 501 to receive the excess downlink data from secondary WIFI AN 532. In response, primary WIFI AN 531 transfers the excess portion of the downlink data to secondary WIFI AN 532, and secondary WIFI AN 532 forwards this excess downlink data to UE 501. Primary WIFI AN 531 transfers the remaining portion of the downlink data directly to UE 501. UE 501 determines the SNR for secondary WIFI AN 532 during this data transfer.

UE 501 subsequently reports its uplink buffer status to primary WIFI AN 531. Primary WIFI AN 531 determines its own downlink buffer status for UE 501. When one of the buffers exceeds a CA threshold, primary WIFI AN 531 determines if secondary WIFI AN 532 has more available bandwidth for UE 501 than AN 531 does. If secondary WIFI AN 532 has more available bandwidth, then primary WIFI AN 531 transfers a message to UE 501 that requests the SNR for secondary WIFI AN 532. UE 501 reports the SNR for secondary WIFI AN 532 to primary WIFI AN 531. Primary WIFI AN 531 compares the SNR for secondary WIFI AN 532 to a corresponding SNR threshold. When secondary WIFI AN 532 meets or exceeds the SNR threshold, primary WIFI AN 531 offloads all of the buffered uplink data in UE 501 and/or all of the buffered downlink data to secondary WIFI AN 532. Note that all of the uplink and/or downlink data is offloaded and not just the excess portion of data above the CA threshold.

To offload the uplink data, primary WIFI AN 531 signals UE 501 to transfer all of its buffered uplink data to secondary WIFI AN 532. Primary WIFI AN 531 signals secondary WIFI AN 532 to receive all of this uplink data from UE 501 and to forward all of the uplink data to primary WIFI AN 531. In response, UE 501 transfers all of its buffered uplink data to secondary WIFI AN 532, and secondary WIFI AN 532 forwards all of this uplink data to primary WIFI AN 531. Primary WIFI AN 531 transfers all of the uplink data to the external system over IWF 505 and UPF 508.

To offload the downlink data, primary WIFI AN 531 signals secondary WIFI AN 532 to receive all of the downlink data from primary WIFI AN 531 and forward all of the downlink data to UE 501. Primary WIFI AN 531 signals UE 501 to receive all of the downlink data from secondary WIFI AN 532. In response, primary WIFI AN 531 transfers all of its buffered downlink data to secondary WIFI AN 532, and secondary WIFI AN 532 forwards all of this downlink data to UE 501.

In some examples, more than one secondary AN is selected and simultaneously used by UE 501 in the manner described herein. For example, UE 501 may simultaneously use both secondary 5GNR ANs 522-523 in parallel. In addition, any one of ANs 521-523, 531-533, and 541-543 may serve as the primary AN for UE 501, and any of the remaining ANs may serve as secondary ANs for UE 501. Thus, 5GNR AN 522 could be the primary AN, and 5GNR AN 523, WIFI AN 533, SAT AN 541 could be the secondary ANs for UE 501. Although not shown for clarity, ANs 521-523, 531-533, and 541-543 may be wirelessly linked to one another to handle signaling and data transfers. For example, 5GNR ANs 521-523 may each be directly linked to SAT ANs 541-543 to handle CA signaling and CA data transfers.

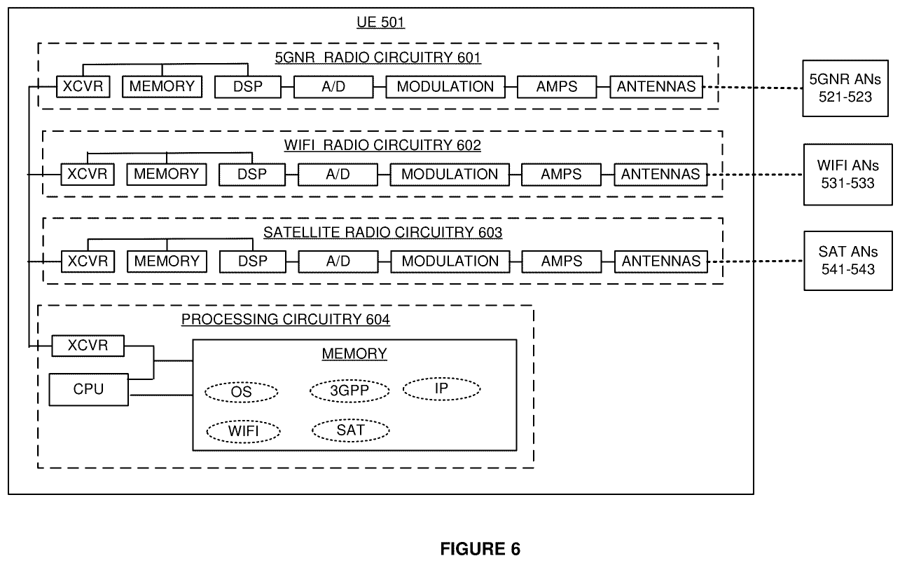

FIG. 6 illustrates exemplary User Equipment (UE) 501 in wireless communication network 500 that selects and uses secondary wireless access nodes 522-523, 532-533, and 542-543. UE 501 comprises an example of wireless user device 101, although device 101 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Radio circuitry 601-603 are each capable of using multiple frequency bands in parallel. Processing circuitry 604 comprises one or more CPUs, one or more memories, and one or more transceivers that are coupled over bus circuitry. The one or more memories in processing circuitry 604 store software like an Operating System (OS), 3GPP Application (3GPP), WIFI Application (WIFI), Satellite Application (SAT), and Internet Protocol Application (IP). The antennas in radio circuitry 601-603 exchange wireless signals with ANs 521-523, 531-533, and 541-543. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

In particular, UE 501 may receive one or more secondary node selection criteria like a measurement type and threshold for secondary ANs, and in response, take the corresponding measurements. UE 501 may select secondary ANs based on the measurements and the selection criteria. UE 501 may report its selection and signal measurements to the primary AN. UE 501 may then simultaneously use the primary AN and the secondary ANs in parallel.

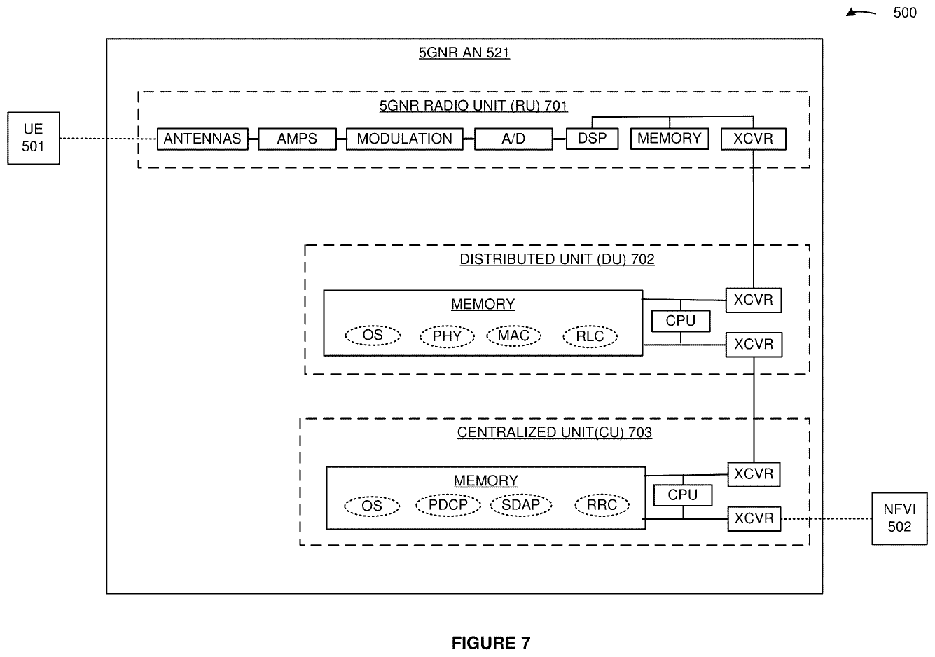

FIG. 7 illustrates exemplary terrestrial 5GNR AN 521 in wireless communication network 500 that selects and uses secondary wireless access nodes 522-523, 532-533, and 542-543. 5GNR AN 521 comprises an example of ANs 110-112 and 522-523, although ANs 110-112 and 522-523 may differ. 5GNR AN 521 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. RU 701 is capable of using multiple frequency bands in parallel. DU 702 comprises memory, CPU, and transceivers that are coupled over bus circuitry. The memory in DU 702 stores operating system and 5GNR network applications for Physical Layer (PHY), Media Access Control (MAC), and Radio Link Control (RLC). DU 702 is capable of using multiple frequency bands in parallel. CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), Radio Resource Control (RRC), and power control (PWR). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 502. The DSP and CPU in RU 701, DU 702, and CU 703 execute the radio applications, operating systems, and network applications to exchange data and signaling between UE 501 and NFVI 502 as described herein.

In particular, primary 5GNR AN 521 may transfer one or more secondary node selection criteria to UE 501 like a measurement type and a threshold. Primary 5GNR AN 521 may select secondary ANs based on the measurements from UE 501 and the one or more secondary node selection criteria. Primary 5GNR AN 521 may select the amount of user data to offload based AN bandwidths and signal measurements from UE 501. Primary 5GNR AN 521 may exchange user data with UE 501 over the selected secondary ANs.

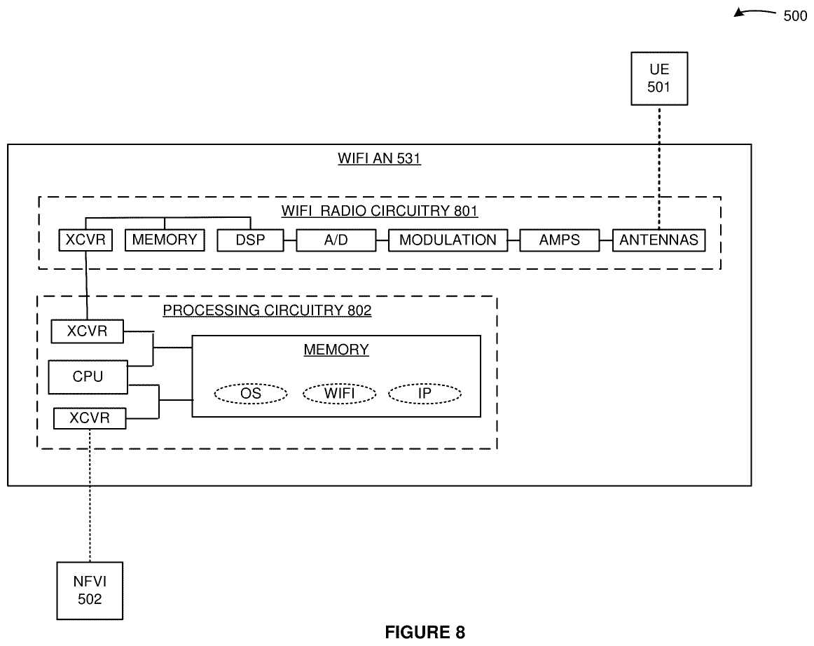

FIG. 8 illustrates exemplary Wireless Fidelity (WIFI) AN 531 in wireless communication network 500 that selects secondary wireless access nodes 522-523, 532-533, and 542-543. WIFI AN 531 comprises an example of ANs 110-112 and 532-533, although ANs 110-112 and 532-533 may differ. WIFI AN 531 comprises WIFI radio circuitry 801 and processing circuitry 802. WIFI radio circuitry 801 comprises antennas, amplifiers, filters, modulation, analog-to-digital interfaces, DSPs, memories, and transceivers that are coupled over bus circuitry. Radio circuitry 801 may use multiple frequency bands in parallel. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio circuitry 801 exchange WIFI signals with UE 501. Transceivers in WIFI radio circuitry 801 are coupled to transceivers in processing circuitry 802. Transceivers in processing circuitry 802 are coupled to transceivers in NFVI 502. In processing circuitry 802, the one or more CPUs retrieve the software from the one or more memories and execute the software to exchange data and signaling between UE 501 and NFVI 502 as described herein.

In particular, WIFI AN 531 may transfer one or more secondary node selection criteria to UE 501 like a measurement type and threshold. Primary WIFI AN 531 may select secondary ANs based on the measurements from UE 501 and the criteria. Primary WIFI AN 531 may select the amount of user data to offload based AN bandwidths and measurements from UE 501. Primary WIFI AN 531 may exchange user data with UE 501 over with the selected secondary ANs.

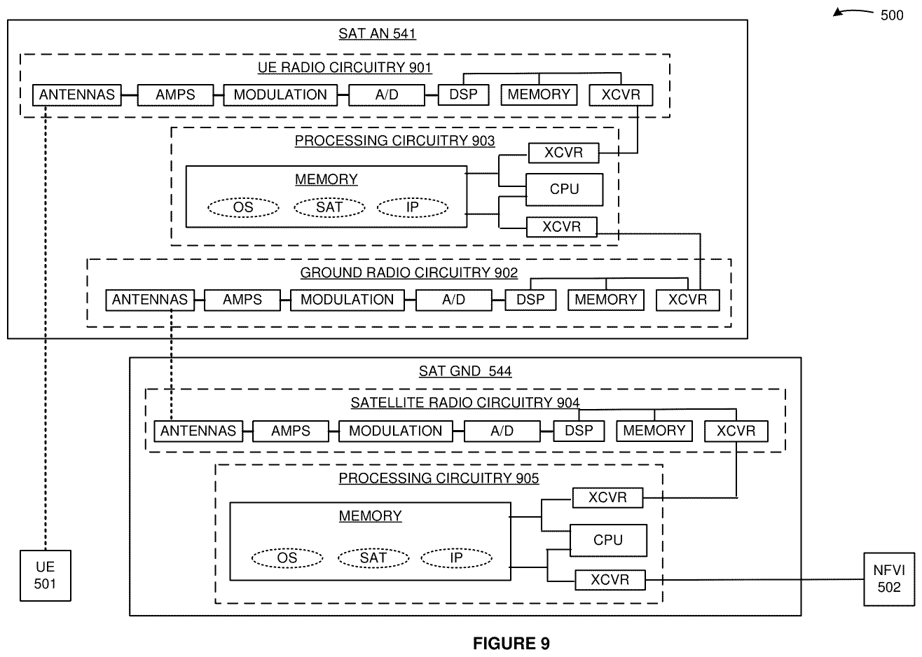

FIG. 9 illustrates exemplary Satellite (SAT) AN 541 and SAT Ground Station (GND) 544 in wireless communication network 500 that selects and uses secondary wireless access nodes 522-523, 532-533, and 542-543. SAT AN 504 and SAT GND 505 comprises an example of ANs 110-112 and 542-543, although ANs 110-112 and 542-543 may differ. SAT AN 541 comprises UE radio 901, ground radio 902, and processing circuitry 903. SAT GND 505 comprises satellite radio circuitry 904 and processing circuitry 905. Radio circuitry 901-902 and 904 comprise antennas, amplifiers, filters, modulation, analog-to-digital interfaces, DSPs, memories, transceivers, and power supplies that are coupled over bus circuitry. Radio circuitry may use multiple frequency bands in parallel. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio circuitry 901 exchange satellite signals with UE 501. Transceivers in UE radio circuitry 901 are coupled to transceivers in processing circuitry 903. Transceivers in processing circuitry 903 are coupled to transceivers in ground radio circuitry 902. The antennas in ground radio circuitry 902 exchange satellite signals with antennas in satellite radio circuitry 904, and the antennas in satellite radio circuitry 904 exchange the satellite signals with ground radio circuitry 902. Transceivers in satellite radio circuitry 904 are coupled to transceivers in processing circuitry 905. Transceivers in processing circuitry 905 are coupled to transceivers in NFVI 502. In processing circuitry 903 and 905, the one or more CPUs retrieve the software from the one or more memories and execute the software to exchange data and signaling between UEs 501 and NFVI 502 as described herein.

In particular, Primary SAT AN 541 may transfer one or more secondary node selection criteria to UE 501 like a measurement type and threshold. Primary SAT AN 541 may select secondary ANs based on the measurements from UE 501 and the threshold. Primary SAT AN 541 may select the amount of user data to offload based AN bandwidths and measurements from UE 501. Primary SAT AN 541 may exchange user data with UE 501 over the selected secondary ANs.

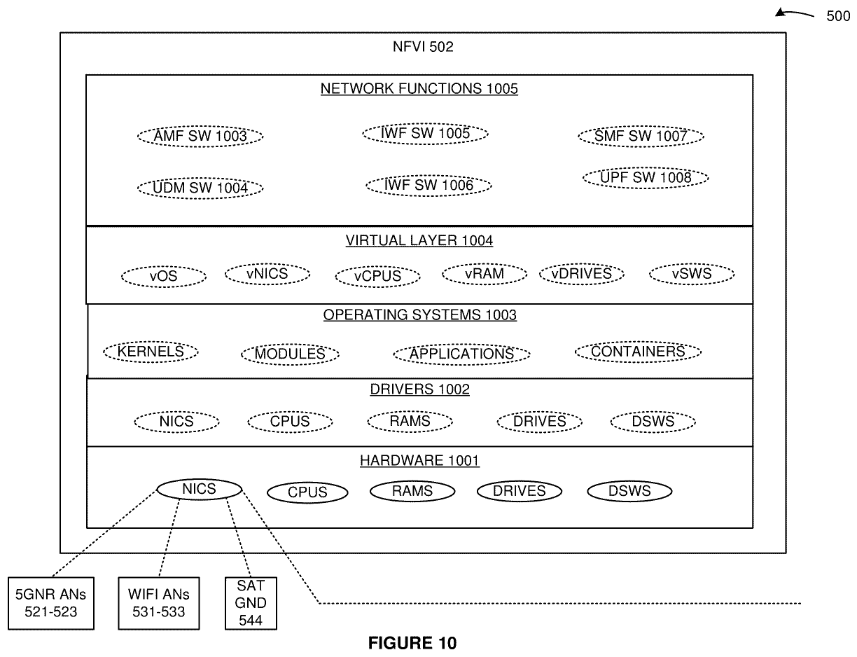

FIG. 10 illustrates exemplary Network Function Virtualization Infrastructure (NFVI) 502 in wireless communication network 500 that selects and uses secondary wireless access nodes 522-523, 532-533, and 542-543. NFVI 502 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF SW 1003, UDM SW 1004, IWF SW 1005-1006, SMF SW 1007, and UPF SW 1008. The NICS in hardware 1001 are coupled to 5GNR ANs 521-523, WIFI ANs 531-533, SAT GND 544, and external systems. Hardware 1001 executes hardware drivers 1002, operating systems 1003, virtual layer 1004, and network functions 1005 to form and operate AMF 503, UDM 504, IWFs 505-506, SMF 507, and UPF 508 as described herein. NFVI 502 may be located at a single site or be distributed across multiple geographic areas.

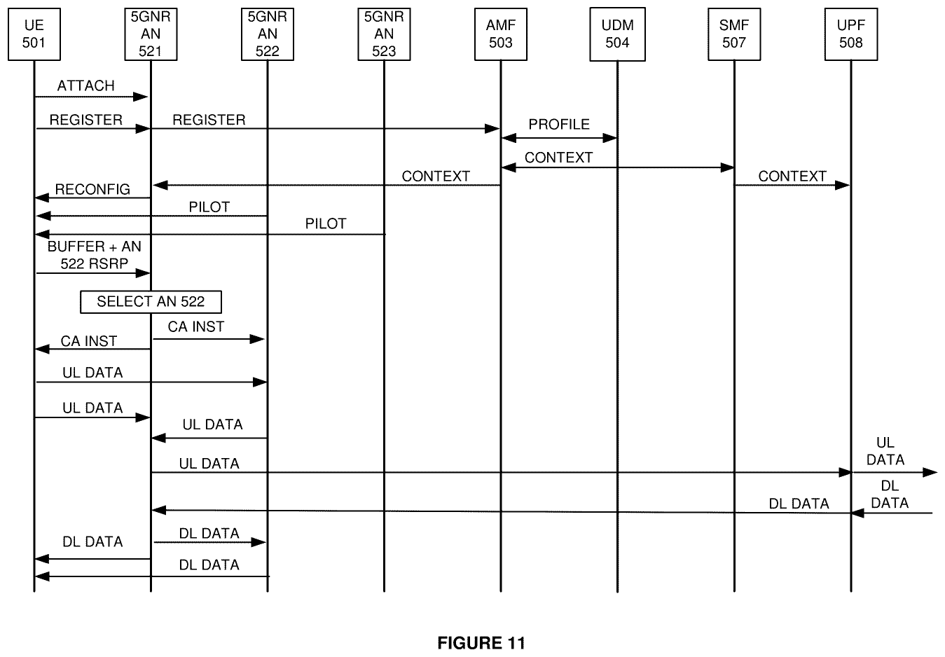

FIG. 11 illustrates an exemplary operation of wireless communication network 500 to select and use secondary wireless access node 522. The operation may differ in other examples. UE 501 attaches to 5GNR AN 521 which will operate as the primary wireless access node. UE 501 registers with AMF 503 over primary 5GNR AN 521 and indicates its Carrier Aggregation (CA) capability to primary 5GNR AN 521. AMF 503 retrieves the subscriber profile for UE 501 from UDM 504. AMF 503 and SMF 507 interact to develop context for UE 501 like device and node identifiers, network addresses, and data rates. SMF 507 transfers the context to UPF 508. AMF 503 transfers the context to primary 5GNR AN 521. Primary 5GNR AN 521 transfers a Radio Resource Control (RRC) Reconfiguration message to UE 501. The RRC Reconfiguration message requests that UE 501 take RSRP measurements for secondary 5GNR ANs 522-523 and report when AN 522 and/or 523 have an RSRP above an RSRP threshold. The RRC Reconfiguration message also requests that UE 501 report SINR, BLER, and CQI measurements for selected ones of secondary 5GNR ANs 522-523. UE 501 processes pilot signals from secondary 5GNR ANs 522-523 to measure their RSRP. In this example, UE 501 reports secondary 5GNR 522 because AN 522 has an RSRP above the RSRP threshold but AN 523 does not. UE 501 reports its buffer status and the RSRP for 5GNR AN 522 to primary 5GNR AN 521.

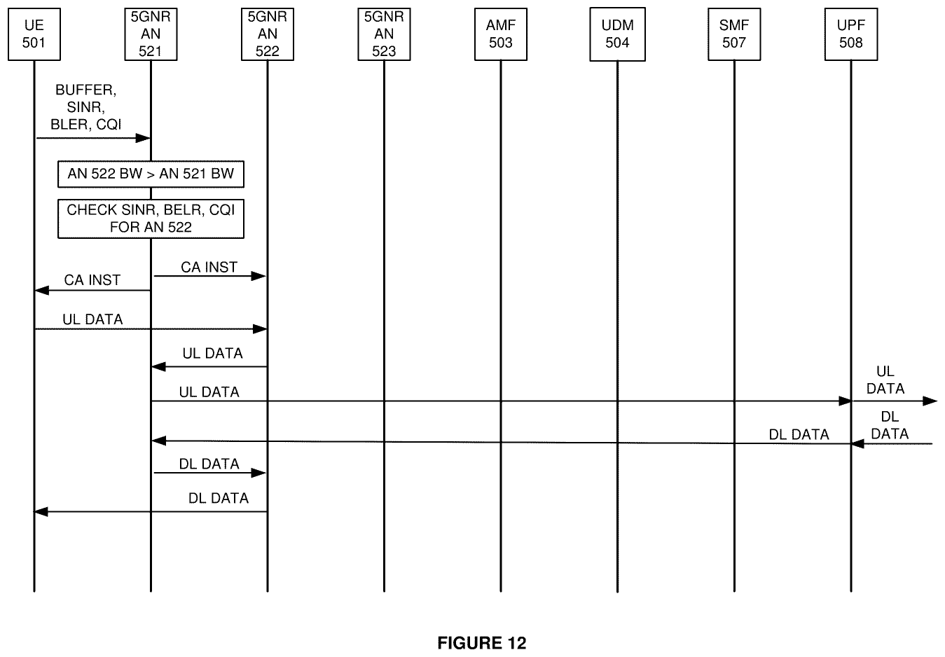

In response to the buffers for UE 501 and 5GNR AN 521 exceeding their CA thresholds, primary 5GNR AN 521 selects secondary 5GNR AN 522 because AN 522 has an RSRP above the RSRP threshold. Primary 5GNR AN 521 signals CA instructions (INST) to UE 501 and secondary 5GNR AN 522 to exchange user data. UE 501 transfers the portion of Uplink (UL) data that exceeds the CA buffer threshold to secondary 5GNR AN 522 and transfers the remaining UL data to primary 5GNR 521. Secondary 5GNR AN 522 transfers the excess portion of UL data to primary 5GNR AN 521. Primary 5GNR AN 521 transfers all of the UL data to an external system (not shown) over UPF 508. Primary 5GNR AN 521 receives Downlink (DL) data for UE 501 from the external system over UPF 508. Primary 5GNR AN 521 transfers the excess portion of DL data that exceeds its CA buffer threshold to secondary 5GNR AN 522. Primary 5GNR AN 521 transfers the remaining DL data to UE 501. Secondary 5GNR AN 522 transfers the excess DL data from 5GNR AN 521 to UE 501. UE 501 measures SINR, BLER, and CQI for secondary 5GNR AN 522 during these data transfers. The operation continues below with a discussion of FIG. 12.

FIG. 12 illustrates an exemplary operation of wireless communication network 500 to select an offload data amount for secondary wireless access node 522. The operation may differ in other examples and continues from the above discussion of FIG. 11. UE 501 reports its buffer status along with the SINR, BLER, and CQI for secondary 5GNR AN 522 to primary 5GNR AN 521. In response to the buffers for UE 501 and primary 5GNR AN 521 exceeding their CA buffer thresholds, primary 5GNR AN 521 determines if the secondary bandwidth of secondary 5GNR AN 522 exceeds the primary bandwidth of primary 5GNR AN 521. If so, then primary 5GNR AN 521 determines if the SINR for secondary 5GNR AN 522 exceeds its SINR threshold. If so, primary 5GNR AN 521 determines if the BLER for secondary 5GNR AN 522 is below its BLER threshold. If so, primary 5GNR AN 521 determines if the CQI for secondary 5GNR AN 523 exceeds its CQI threshold. If so, primary 5GNR AN 521 signals CA instructions to UE 501 and secondary 5GNR AN 522 to exchange all of the buffered user data. UE 501 transfers all of its buffered UL data to secondary 5GNR AN 522. Secondary 5GNR AN 522 transfers all of this UL data to primary 5GNR AN 521. Primary 5GNR AN 521 transfers all of the UL data to the external system over UPF 508. Primary 5GNR AN 521 receives DL data for UE 501 from the external system over UPF 508. Primary 5GNR AN 521 transfers all of its buffered DL data to secondary 5GNR AN 522. Secondary 5GNR AN 522 transfers all of this DL data to UE 501.

Advantageously, wireless communication network 500 selects and uses secondary wireless access nodes 522-523, 532-533, and 542-543 that have effective wireless communications with UE 501. Moreover, primary wireless access nodes 521, 531, and 541 may efficiently offload all of their user data for UE 501 to secondary wireless access nodes 522-523, 532-533, and 542-543.

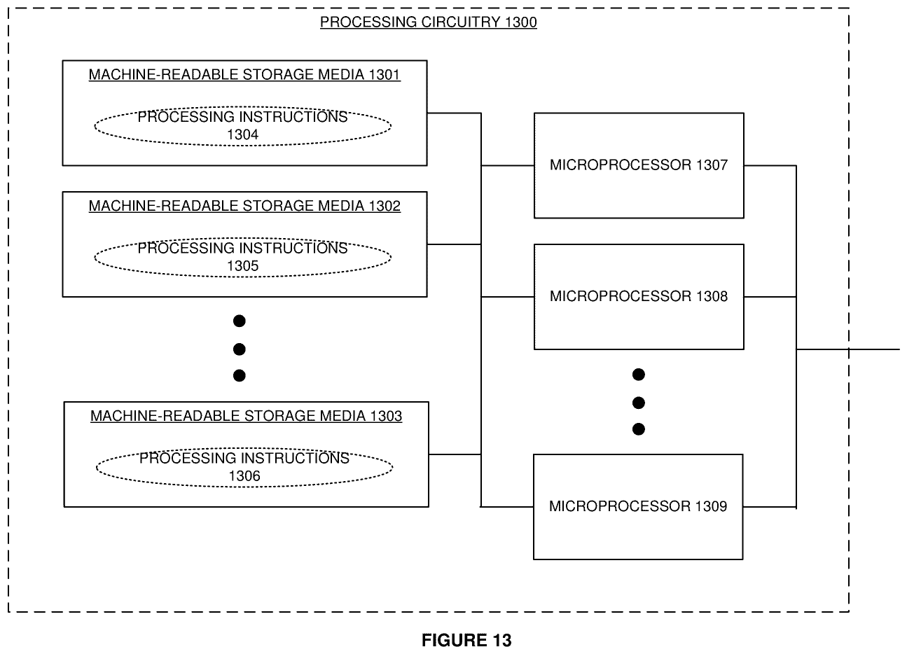

FIG. 13 illustrates exemplary processing circuitry 1300 to select and use secondary wireless access nodes. Processing circuitry 1300 comprises an example of data system 100, wireless data system 400, and wireless communication network 500, although system 100, system 400, and network 500 may differ. Processing circuitry 1300 comprises machine-readable storage media 1301-1303 and microprocessors 1307-1309 that are communicatively coupled. Machine-readable storage media 1301-1303 store processing instructions 1304-1306 in a non-transitory manner. Microprocessors 1307-1309 comprise DSPs, CPUs, GPUs, ASICs, and/or some other data processing hardware. Machine-readable storage media 1301-1303 comprises RAM, flash circuitry, disk drives, and/or some other type of data storage apparatus. Microprocessors 1307-1309 retrieve processing instructions 1304-1306 from non-transitory machine-readable storage media 1301-1303. Microprocessors 1307-1309 execute processing instructions 1304-1306 to select and select and use secondary ANs as described above. The amount of storage media, microprocessors, processing instructions that are shown in FIG. 13 may vary in other examples.

The wireless communication system circuitry described above comprises computer hardware and software that form special-purpose data communication circuitry to select and use secondary wireless access nodes. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to select and use the secondary wireless access nodes.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
wirelessly communicating with a user device via a primary wireless access node;
wirelessly transferring one or more secondary node selection criteria to the user device;
wirelessly receiving signal measurements for one or more of the secondary wireless access nodes from the user device in response to the one or more secondary node selection criteria;
configuring the one or more of the secondary wireless access nodes to communicate with the user device in response to the signal measurements and the one or more secondary node selection criteria; and
wirelessly communicating with user device via the one or more of the configured secondary wireless access nodes.

2. The method of claim 1 wherein:
wirelessly transferring the one or more secondary node selection criteria comprises transferring a Reference Signal Received Power (RSRP) threshold;
wirelessly receiving the signal measurements comprises receiving RSRP measurements; and
configuring the one or more of the secondary wireless access nodes comprises configuring the one or more of the secondary wireless access nodes in response to the RSRP measurements and the RSRP threshold.

3. The method of claim 1 wherein:
wirelessly transferring the one or more secondary node selection criteria comprises transferring a Reference Signal Received Quality (RSRQ) threshold;
wirelessly receiving the signal measurements comprises receiving RSRQ measurements in response to the RSRQ threshold; and
configuring the one or more of the secondary wireless access nodes comprises configuring the one or more of the secondary wireless access nodes in response to the RSRQ measurements and the RSRQ threshold.

4. The method of claim 1 wherein:
wirelessly transferring the one or more secondary node selection criteria comprises transferring a Signal-to-Interference and Noise Ratio (SINR) threshold;
wirelessly receiving the signal measurements comprises receiving SINR measurements; and
configuring the one or more of the secondary wireless access nodes comprises configuring the one of the secondary wireless access nodes in response to the SINR measurements and the SINR threshold.

5. The method of claim 1 wherein the one or more secondary node selection criteria excludes ones of the secondary wireless access nodes that require antenna switching by the user device.

6. The method of claim 1 wherein the one or more secondary node selection criteria excludes ones of the secondary wireless access nodes that do not share a NodeB with the primary wireless access node.

7. The method of claim 1 wherein wirelessly transferring the one or more secondary node selection criteria to the user device comprises transferring the one or more secondary node selection criteria in a Radio Resource Control (RRC) Reconfiguration message.

8. The method of claim 1 wherein wirelessly receiving the signal measurements from the user device comprises receiving the signal measurements in a Radio Resource Control (RRC) Reconfiguration Complete message.

9. A method comprising:
wirelessly communicating with a primary wireless access node;
wirelessly receiving one or more secondary node selection criteria from the primary wireless access node;
determining signal measurements for the secondary wireless access nodes in response to the one or more secondary node selection criteria;
selecting one or more of the secondary wireless access nodes in response to the signal measurements and the one or more secondary node selection criteria;
wirelessly transferring the signal measurements for the selected one or more of the secondary wireless access nodes to the primary wireless access node; and
wirelessly communicating with the one or more of the selected secondary wireless access nodes.

10. The method of claim 9 wherein:
wirelessly receiving the one or more secondary node selection criteria comprises receiving a Reference Signal Received Power (RSRP) threshold;
determining the signal measurements comprises determining RSRP measurements;
selecting the one or more of the secondary wireless access nodes comprises selecting the one or more of the secondary wireless access nodes in response to the RSRP measurements and the RSRP threshold.

11. The method of claim 9 wherein wirelessly receiving the one or more secondary node selection criteria from the primary wireless access node comprises receiving the one or more secondary node selection criteria in a Radio Resource Control (RRC) Reconfiguration message.

12. The method of claim 9 wherein wirelessly transferring the signal measurements to the primary wireless access node comprises transferring the signal measurements in a Radio Resource Control (RRC) Reconfiguration Complete message.

13. A wireless communication system comprising:
a primary wireless access node to wirelessly communicate with a user device;
the primary wireless access node to wirelessly transfer one or more secondary node selection criteria to the user device;
the primary wireless access node to wirelessly receive signal measurements for one or more of the secondary wireless access nodes from the user device in response to the one or more secondary node selection criteria;
the primary wireless access node to configure the one or more of the secondary wireless access nodes to communicate with the user device in response to the signal measurements and the one or more secondary node selection criteria; and
the one or more of the configured secondary wireless access nodes to wirelessly communicate with user device.

14. The wireless communication system of claim 13 wherein:
the one or more secondary node selection criteria comprises a Reference Signal Received Power (RSRP) threshold; and
the signal measurements comprise RSRP measurements.

15. The wireless communication system of claim 13 wherein:
the selection factor comprises a Reference Signal Received Quality (RSRQ) threshold; and
the signal measurements comprise RSRQ measurements.

16. The wireless communication system of claim 13 wherein:
the selection factor comprises a Signal-to-Interference and Noise Ratio (SINR) threshold; and
the signal measurements comprise SINR measurements.

17. The wireless communication system of claim 13 wherein the one or more secondary node selection criteria excludes ones of the secondary wireless access nodes that require antenna switching by the user device.

18. The wireless communication system of claim 13 wherein the one or more secondary node selection criteria excludes ones of the secondary wireless access nodes that do not share a NodeB with the primary wireless access node.

19. The wireless communication system of claim 13 wherein the primary wireless access node is to transfer the one or more secondary node selection criteria to the user device in a Radio Resource Control (RRC) Reconfiguration message.

20. The wireless communication system of claim 13 wherein the primary wireless access node is to receive the signal measurements from the user device in a Radio Resource Control (RRC) Reconfiguration Complete message.
